(19) United States
(12) Patent Application Publication
(10) Pub. No.: US 2026/0230176 A1
(43) Pub. Date: Aug. 6, 2026

(54) HYBRID WAVEFORMS FOR ENERGY HARVESTING (EH)-CAPABLE DEVICES

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 19/042,308

(22) Filed: Jan. 31, 2025

(51) Int. Cl. H02J 50/00; H02J 50/80; H04B 7/04; H04B 7/22

(52) U.S. Cl. CPC H04B 7/22; H04B 7/04013; H02J 50/001

(57) ABSTRACT

Methods, systems, and devices for wireless communications are described. Techniques described herein may enable an energy harvesting (EH)-capable device to backscatter a signal from a reader device by generating a first amplitude level associated with a first reflection phase and a second reflection phase and an additional amplitude for a third reflection phase. The additional amplitude may be associated with reflection of a received signal during an “OFF” mode of the EH-capable device. In some examples, the reader device may indicate one or more waveform parameters such as time durations associated with reflection phases to the EH-capable device, and the EH-capable device may reflect a signal to the reader device in accordance with the waveform parameters using the “OFF” state.

### FIELD OF TECHNOLOGY

The following relates to wireless communications, including hybrid waveforms for energy harvesting (EH)-capable devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an energy harvesting (EH)-capable device is described. The method may include communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, receiving a signal from a wireless device, and transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

An EH-capable device for wireless communications is described. The EH-capable device may include one or more memories storing processor executable code, and one or more processors coupled with the one or more memories. The one or more processors may individually or collectively be operable to execute the code to cause the EH-capable device to communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, receive a signal from a wireless device, and transmit a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Another EH-capable device for wireless communications is described. The EH-capable device may include means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, means for receiving a signal from a wireless device, and means for transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

A non-transitory computer-readable medium storing code for wireless communications is described. The code may include instructions executable by one or more processors to communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, receive a signal from a wireless device, and transmit a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Some examples of the method, energy harvestings, and non-transitory computer-readable medium described herein may further include operations, features, means, or instructions for transmitting an indication of the first amplitude level.

In some examples of the method, energy harvestings, and non-transitory computer-readable medium described herein, the control signaling may be communicated during a synchronization phase associated with the EH-capable device and a user equipment (UE).

In some examples of the method, energy harvestings, and non-transitory computer-readable medium described herein, the first time duration and the second time duration may be associated with a period of the hybrid waveform.

In some examples of the method, energy harvestings, and non-transitory computer-readable medium described herein, the first time duration and the second time duration may be based on the first amplitude level and the first time duration and the second time duration may be associated with a set of power values associated with a set of harmonic frequencies.

In some examples of the method, energy harvestings, and non-transitory computer-readable medium described herein, the set of power values include one or more minimum power values associated with the set of harmonic frequencies.

Some examples of the method, energy harvestings, and non-transitory computer-readable medium described herein may further include operations, features, means, or instructions for receiving control signaling indicating that the hybrid waveform may be enabled based on the set of power values, a decrease associated with a first-order harmonic frequency, or both.

In some examples of the method, energy harvestings, and non-transitory computer-readable medium described herein, the EH-capable device may be an ambient internet-of-things (A-IoT) device or a reflective intelligent surface (RIS).

A method for wireless communications by a wireless device is described. The method may include communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, transmitting a signal to an EH-capable device, and receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

A wireless device for wireless communications is described. The wireless device may include one or more memories storing processor executable code, and one or more processors coupled with the one or more memories. The one or more processors may individually or collectively be operable to execute the code to cause the wireless device to communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, transmit a signal to an EH-capable device, and receive a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Another wireless device for wireless communications is described. The wireless device may include means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, means for transmitting a signal to an EH-capable device, and means for receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

A non-transitory computer-readable medium storing code for wireless communications is described. The code may include instructions executable by one or more processors to communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform, transmit a signal to an EH-capable device, and receive a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Some examples of the method, wireless devices, and non-transitory computer-readable medium described herein may further include operations, features, means, or instructions for receiving, from the EH-capable device, an indication of the first amplitude level.

Some examples of the method, wireless devices, and non-transitory computer-readable medium described herein may further include operations, features, means, or instructions for identifying the first amplitude level from a database.

In some examples of the method, wireless devices, and non-transitory computer-readable medium described herein, the first time duration and the second time duration may be based on the first amplitude level and the first time duration and the second time duration may be associated with a set of power values associated with a set of harmonic frequencies.

In some examples of the method, wireless devices, and non-transitory computer-readable medium described herein, the set of power values include one or more minimum power values associated with the set of harmonic frequencies.

Some examples of the method, wireless devices, and non-transitory computer-readable medium described herein may further include operations, features, means, or instructions for determining to enable the hybrid waveform based on the set of power values, a decrease associated with a first-order harmonic frequency, or both and transmitting, to the EH-capable device, control signaling indicating that the hybrid waveform may be enabled.

In some examples of the method, wireless devices, and non-transitory computer-readable medium described herein, the control signaling may be communicated during a synchronization phase associated with the EH-capable device and the wireless device.

In some examples of the method, wireless devices, and non-transitory computer-readable medium described herein, the first time duration and the second time duration may be associated with a period of the hybrid waveform.

In some examples of the method, wireless devices, and non-transitory computer-readable medium described herein, the EH-capable device may be an A-IoT device or a RIS.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports hybrid waveforms for energy harvesting (EH)-capable devices in accordance with one or more aspects of the present disclosure.

FIG. 2 shows an example of a wireless communications system that supports hybrid waveforms for EH-capable devices in accordance with one or more aspects of the present disclosure.

FIG. 3 shows an example of a harmonic level diagram that supports hybrid waveforms for EH-capable devices in accordance with one or more aspects of the present disclosure.

FIG. 4 shows an example of a process flow that supports hybrid waveforms for EH-capable devices in accordance with one or more aspects of the present disclosure.

FIGS. 5 and 6 show block diagrams of devices that support hybrid waveforms for EH-capable devices in accordance with one or more aspects of the present disclosure.

FIG. 7 shows a block diagram of a communications manager that supports hybrid waveforms for EH-capable devices in accordance with one or more aspects of the present disclosure.

FIG. 8 shows a diagram of a system including a device that supports hybrid waveforms for EH-capable devices in accordance with one or more aspects of the present disclosure.

FIGS. 9 through 11 show flowcharts illustrating methods that support hybrid waveforms for EH-capable devices in accordance with one or more aspects of the present disclosure.

### DETAILED DESCRIPTION

In some wireless communications systems, an energy harvesting (EH)-capable device (e.g., an ambient internet-of-things (A-IoT) device or a reflective intelligent surface (RIS)) may communicate with a reader device (e.g., a transmitting device, a user equipment (UE)) by backscattering a signal received from the reader device. For example, the EH-capable device may reflect the received signal. The EH-capable device may reflect the signal with one or more reflection phases, which may enable a frequency shift and therefore decrease self-interference at the reader device. In some examples, the one or more reflection phases may give rise to higher-order (e.g., greater than first order) harmonic frequencies, which may decrease a quality of communications between the reader device and the EH-capable device. The EH-capable device may accordingly reflect signals with multiple amplitude levels in addition to the one or more reflection phases, which may decrease a power level of the higher-order harmonic frequencies. However, generating the multiple amplitude levels may increase a complexity of the EH-capable device, which may increase a manufacturing cost and power consumption associated with the EH-capable device.

Accordingly, techniques described herein may enable the EH-capable device to generate an additional amplitude associated with a reflected signal that includes an “OFF” state. For example, the EH-capable device may reflect some residual energy in examples in which the EH-capable device may not be actively generating a waveform with a first amplitude, which may cause a second amplitude of a reflected signal that is different from the first amplitude. In some examples, the reader device may indicate one or more waveform parameters (e.g., a duration associated with the one or more reflection phases) to the EH-capable device, and the EH-capable device may reflect a signal to the reader device in accordance with the waveform parameters using the “OFF” state. Such techniques may decrease a power level of higher-order harmonic frequencies, which may increase a quality of communications in the wireless communications system without increasing a complexity of the EH-capable device.

Aspects of the disclosure are initially described in the context of wireless communications systems. Aspects of the disclosure are further illustrated by and described with reference to harmonic level diagrams, process flows, apparatus diagrams, system diagrams, and flowcharts that relate to hybrid waveforms for EH-capable devices.

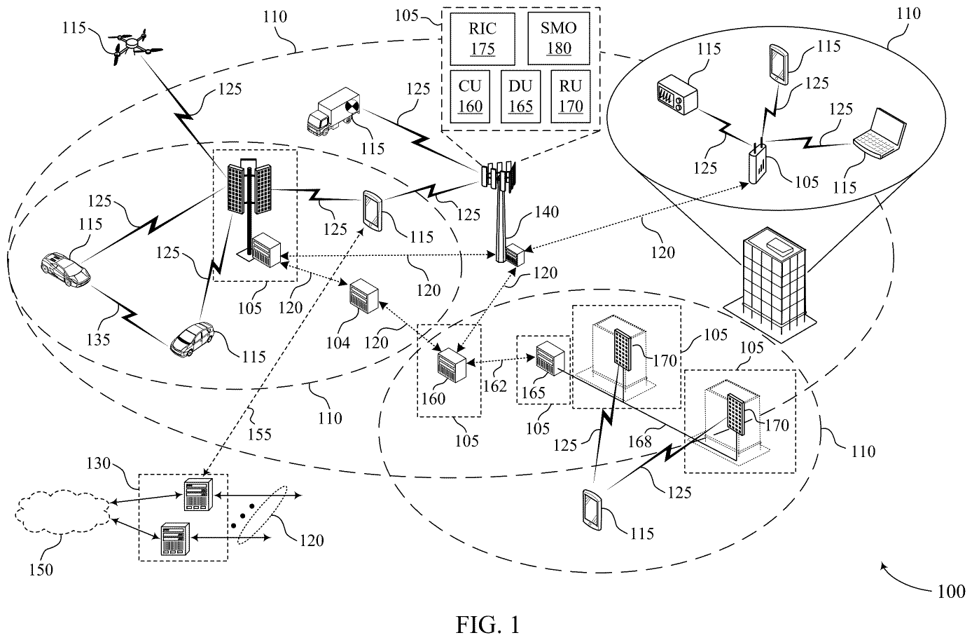

FIG. 1 shows an example of a wireless communications system 100 that supports hybrid waveforms for EH-capable devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support hybrid waveforms for EH-capable devices as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, one or more devices of the wireless communications system 100 may support using surfaces (e.g., configurable intelligent surfaces, reconfigurable intelligent surfaces (RISs), meta-surfaces) for communications. For example, the surfaces may transmit or reflect waves at a desired angle to support communications between one or more devices of the wireless communications system 100. Some UEs 115 (e.g., vehicles) may include such surfaces to facilitate communications between the UEs 115 and one or more other UEs 115 (e.g., vehicle connectivity, V2X communications). Additionally, or alternatively, the surfaces may support communications with one or more UEs 115 that are operating within the vehicles.

In some examples, an A-IoT device (e.g., an EH-capable device), which may be an example of a UE 115, may be a passive, semi-passive, or active A-IoT device. For example, if the A-IoT device is a passive device, the A-IoT device may communicate using backscattering techniques. If the A-IoT device is a semi-passive device, the A-IoT device may communicate using backscattering techniques and using additional energy in energy storage (e.g., powering integrated circuit (IC), amplifying reflected signal) with LO turn off and amplifier turn on. If the A-IoT device is an active device, the A-IoT device may communicate with active signal generation method using energy stored in energy storage (e.g., amplifying signals, using active RF components, better filtering, more complex baseband (BB) processing, and using clocks with higher accuracy) with LO turn on and amplifier turn on.

In some examples of the wireless communications system 100, an EH-capable device may backscatter a signal from a reader device (e.g., a wireless device, a UE 115) by generating a first amplitude level associated with a first reflection phase and a second reflection phase and an additional amplitude for a third reflection phase. The additional amplitude may be associated with reflection of a received signal using an “OFF” mode of the waveform. For example, the EH-capable device may reflect an amount of residual energy while the EH-capable device is not actively reflecting a signal with an amplitude, which may cause an amplitude of the reflected signal that is different from the first amplitude level. In some examples, the reader device may indicate one or more waveform parameters (e.g., a duration associated with the one or more reflection phases) to the EH-capable device, and the EH-capable device may reflect a signal to the reader device in accordance with the waveform parameters using the “OFF” state. Such techniques may decrease a power level of higher-order harmonic frequencies, which may increase a quality of communications in the wireless communications system (e.g., by avoiding interference due to the presence of higher-order harmonics) without increasing a complexity of the EH-capable device.

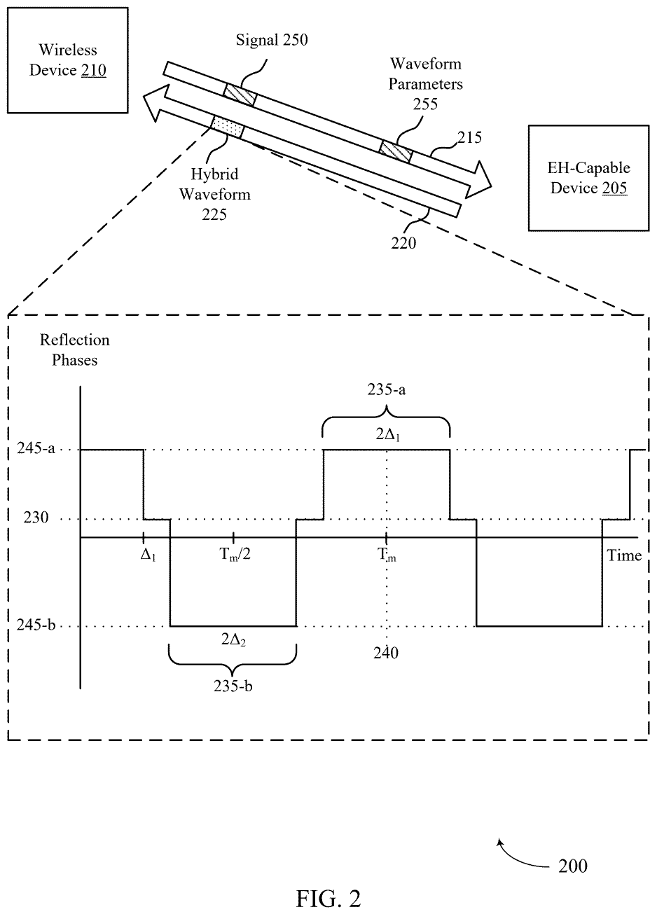

FIG. 2 shows an example of a wireless communications system 200 that supports hybrid waveforms for EH-capable devices in accordance with one or more aspects of the present disclosure. The wireless communications system 200 may implement or may be implemented by aspects of the wireless communications system 100. For example, the wireless communications system 200 may be implemented by a wireless device 210 (e.g., a reader device) or an EH-capable device 205, which may be examples of UEs 115 or network entities 105 as described with reference to FIG. 1. For example, the EH-capable device 205 may be an example of a RIS or an A-IoT device as described with reference to FIG. 1.

In some examples of the wireless communication system 200, a wireless device 210 may communicate with an EH-capable device 205 (e.g., an A-IoT device, a RIS, a low-power network node) via backscattering techniques. For example, the wireless device 210 (e.g., a transmitter) may transmit a signal 250 to the EH-capable device via a forward link channel 215, and the EH-capable device 205 may transmit a second signal to the wireless device 210 via a backward link channel 220 based on a backscatter of the signal 250. In some examples, the EH-capable device 205 may use reflection modulation (RM) to transmit the second signal. That is, the EH-capable device 205 may modulate the incident signal during reflection of the signal 250 to generate the second signal. In some examples, the EH-capable device 205 may transmit the second signal to a different network node (e.g., a receiver, a wireless device different from the wireless device 210). Such techniques may be referred to as a bistatic setting of the wireless communication system 200.

In some examples, the EH-capable device 205 may perform RM by using periodic waveforms. For example, the periodic waveforms may govern switching patterns of antenna loads of the EH-capable device 205. The switching patterns may induce a desired phase shift on the reflected wave, which may enable a frequency shift of the second signal and reduce (e.g., avoid) self-interference at the wireless device 210 through a relatively low order (e.g., 1st order) harmonic frequency. In some examples, however, periodic load switching patterns may result in one or more higher-order harmonic frequencies.

In some examples, to reduce (e.g., eliminate) the higher-order harmonic frequencies, the EH-capable device 205 may use a multi-level waveform. For example, the multi-level waveforms may reduce the higher-order harmonics due to a relatively more smooth transition between reflection phases of the second signal. That is, a relatively more sharp transition between a reflection phase 245-a and a reflection phase 245-b of the second signal may result in relatively more higher-order harmonics. As an illustrative example, a 2-level waveform such as

$$s ( t ) = {\sum }_{l = 1}^{∞} \frac{4}{πℓ} sin \frac{2 πℓ t}{{T}_{m}} ,$$

where Tₘ is a period of the waveform, may give rise to relatively more higher-order (e.g., 3rd, 5th, and respective higher-order) harmonic frequencies as compared to a 4-level waveform such as s̅(t)=s₀(t)+s₁(t)+s₂(t), where

$${s}_{0} ( t ) = \sqrt{2} s ( t + \frac{{T}_{m}}{4} ) , {s}_{1} ( t ) = s ( t + \frac{{T}_{m}}{8} ) , and$$

$${s}_{2} ( t ) = s ( t + \frac{3 {T}_{m}}{8} )$$

$$( e . g . , {\sum }_{l = 1}^{∞} \frac{4 \sqrt{2}}{πℓ} sin \frac{πℓ}{4} [ 2 cos ( \frac{πℓ}{4} ) + \sqrt{2} ] cos \frac{2 πℓ t}{{T}_{m}} ) .$$

Such techniques may be referred to as harmonic management.

In such examples, however, the EH-capable device 205 may include a relatively more sophisticated antenna load design (e.g., complex-valued antenna loads, multiple antenna loads of different amplitudes), which may increase a complexity and manufacturing cost associated with the EH-capable device 205. For example, the multi-level waveforms may include multiple amplitude levels generated at the EH-capable device 205, which may cause a relatively more complex design as compared to EH-capable devices 205 that may change a reflection phase while keeping a same amplitude.

Accordingly, techniques described herein may enable a relatively more simple waveform that may reduce (e.g., eliminate, suppress) higher-order harmonics. For example, the EH-capable device 205 may reflect a waveform having an “OFF” state (e.g., such as in on-off keying (OOK) waveforms) and one or more out-of-phase “ON” states with a same amplitude (e.g., such as in binary phase shift keying (BPSK)) to result in a relatively more smooth phase transition between “ON” states (e.g., +1 and −1) by adding a separate amplitude level € (e.g., a reflection ratio, a residual amplitude associated with residual reflection by the EH-capable device 205), which may suppress on or more higher-order harmonic frequencies and therefore reduce self-interference at the wireless device 210. Such a waveform may be referred to herein as a hybrid waveform 225. In some examples, the hybrid waveform 225 may be associated with a relatively lower (e.g., but tolerable) transmission power than some other signals (e.g., the second signal).

In some examples, the “ON” states may be associated with the reflection phase 245-a and the reflection phase 245-b, respectively, and the “OFF” state may be associated with a reflection phase 230. The amplitude level € (e.g., amplitude of reflection phase 230) may not be generated by designing special antenna loads as some other multi-level waveforms. For example, the amplitude level e may be a non-zero residual amplitude reflected by the EH-capable device 205 as an intermediate, OFF state, of the hybrid waveform 225 when transitioning between out-of-phase ON states. That is, the EH-capable device 205 may generate the amplitude level e by switching (e.g., moving, transitioning) to the “OFF” state when transitioning between the out of phase ON state reflection phases.

In some examples, the hybrid waveform 225 may be associated with one or more durations. For example, the hybrid waveform 225 may have a period 240 (e.g., Tₘ). The reflection phase 245-a of the hybrid waveform 225 may have a duration 235-a (e.g., 2Δ₁), and the reflection phase 245-b of the hybrid waveform 225 may have a duration 235-b (e.g., 2Δ₂). The reflection phase 230 (e.g., the reflection phase associated with the “OFF” state) may be associated with a third duration (e.g., a duration between the duration 235-a and the duration 235-b).

In some examples, to employ the hybrid waveform 225 for antenna load switching patterns, the wireless device 210 (e.g., the transmitter of the signal 250) may share waveform parameters 255 (e.g., specifications of the waveform, such as Tₘ, Δ₁, and/or Δ₂) with the EH-capable device 205. In examples in which the transmitter (e.g., the wireless device 210) is different from a receiver (e.g., a reader, another wireless device, a distinct network node) of the hybrid waveform 225, the wireless device 210 may indicate the waveform parameters 255 to the receiver. For example, in examples in which the EH-capable device 205 is a RIS, the receiver may be different from the transmitter (e.g., the wireless device 210), and the transmitter may accordingly share the waveform parameters 255 with the receiver.

In some examples, the wireless device 210 may determine whether to use the hybrid waveform 225 based on a respective decrease in a power level of the 1st order harmonic frequencies and/or the higher-order harmonic frequencies. For example, if the decrease of the power level of the 1st order harmonic frequencies is less than a threshold (e.g., 0.67 decibels (dB), a threshold based on reports from the receiver or reader device), the wireless device 210 may determine to enable the hybrid waveform 225. Additionally, or alternatively, if an importance (e.g., priority) associated with suppressing the higher-order frequencies is greater than a threshold, the wireless device 210 may determine to enable the hybrid waveform 225. In examples in which the wireless device 210 determines to enable the hybrid waveform 225, the wireless device 210 may output control signaling to the EH-capable device 205 that indicates for the EH-capable device 205 to reflect the signal 250 in accordance with the waveform parameters 255.

In some aspects, the wireless device 210 (e.g., the transmitter) may determine values of the waveform parameters 255 (e.g., Tₘ, Δ₁, Δ₂, and/or a duration of the “OFF” state) based on the reflection ratio e during the “OFF” state of the hybrid waveform output by the EH-capable device 205 (e.g., due to a non-perfect impedance matching for the incident signal 250 and/or other reflections from surfaces other than an antenna aperture of the EH-capable device 205, which may be referred to as uncontrollable reflections). In some examples, the wireless device 210 may determine one or more OFF-state specs associated with the EH-capable device 205 dynamically (e.g., by receiving a message from the EH-capable device 205 that indicates a value of the reflection ratio) or a priori (e.g., via a database). For example, in wireless communication systems 200 that are associated with a relatively larger quantity of EH-capable devices 205 (e.g., A-IoT devices, NFC tags), the wireless communications system 200 may include a database of reflection ratios associated with each EH-capable device 205, which may reduce overhead associated with engaging with each EH-capable device 205 to determine a respective spec (e.g., each respective reflection ratio) of each EH-capable device 205.

The wireless device 210 may select values for Tₘ, Δ₁, and/or Δ₂ based on the reflection ratio E. For example, the wireless device 210 may compute respective values or ratios associated with Tₘ, Δ₁, and/or Δ₂ that may result in a relatively highest decrease in a power associated with higher-order harmonic frequencies and/or a decrease in the power associated with the 1st order harmonic frequency that is less than the threshold. As an illustrative example, for a reflection ratio ϵ=0.25, the wireless device may determine to use waveform parameters 255 that satisfy a ratio

$$\frac{{Δ}_{1}}{{T}_{m}} = 0.16 .$$

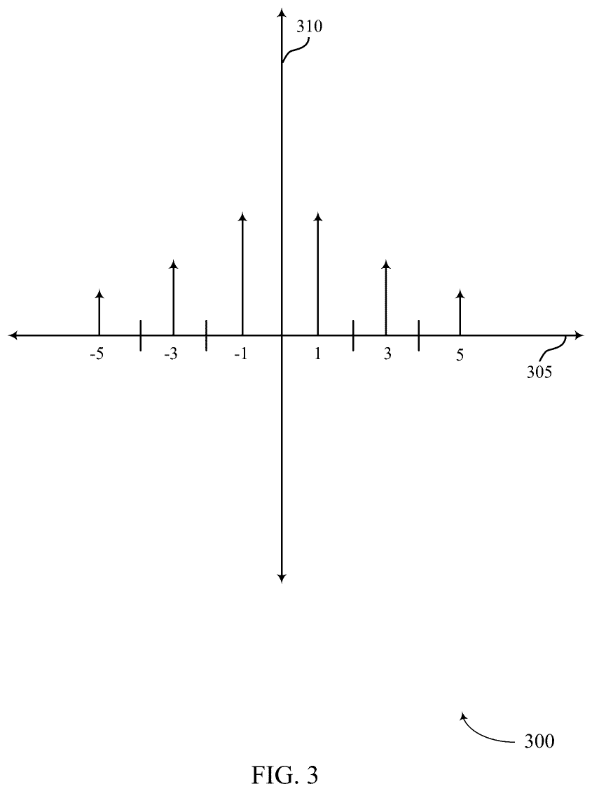

Such techniques are described in further detail with reference to FIG. 3.

FIG. 3 shows an example of a harmonic level diagram 300 that supports hybrid waveforms for EH-capable devices in accordance with one or more aspects of the present disclosure. The harmonic level diagram 300 may implement or may be implemented by aspects of the wireless communications system 100 or the wireless communications system 200. For example, the harmonic level diagram 300 may be implemented by a wireless device (e.g., a reader device) or an EH-capable device, which may be examples of UEs 115 or network entities 105 as described with reference to FIG. 1. For example, the EH-capable device may be an example of a RIS or an A-IoT device as described with reference to FIG. 1.

In some examples, as described herein with reference to FIG. 2, a wireless device (e.g., a transmitter) may output a signal to an EH-capable device. The EH-capable device may reflect (e.g., backscatter) the signal using a hybrid waveform, which may decrease a power 310 associated with one or more higher-order harmonic frequencies. As illustrated with reference to FIG. 3, the higher-order harmonic frequencies may refer to harmonic frequencies with an order 305 (e.g., [symbol] ) of −5, −3, 3, 5, and so on. A 1st order harmonic frequency may refer to harmonic frequencies with an order 305 (e.g., [symbol] ) of −1 or 1.

In some examples, the hybrid waveform may be associated with one or more waveform parameters, such as a period Tₘ, a duration of a first reflection phase 2Δ₁, and/or a duration of a second reflection phase 2Δ₂. In some examples, the wireless device may select values and/or ratios associated with the waveform parameters. For example, the wireless device may select values of the waveform parameters that result in a decrease in power 310 of the higher-order harmonic frequencies that is greater than a first threshold (e.g., such that the power 310 of the higher-order harmonic frequencies is reduced or minimized), a decrease in in power 310 of the 1st-order harmonic frequencies that is less than a second threshold, or both. In other words, the wireless device may optimize a suppression of higher-order harmonic frequencies and a loss of 1st-order harmonic frequencies via selection of Tₘ, Δ₁, and/or Δ₂. The wireless device may select the values for the waveform parameters based on a reflection ratio E associated with the EH-capable device.

In some examples, a harmonic suppression capability associated with the hybrid waveform may be illustrated with reference to a Fourier series representation of a 3-level hybrid waveform (e.g., with a first reflection phase of a first amplitude, a second reflection phase of the first amplitude, and a third reflection phase of a second amplitude equal to the reflection ratio of the EH-capable device). As an illustrative example, the hybrid waveform may be represented by

$$s ( t ) = {\sum }_{ℓ = - ∞}^{∞} \frac{4}{πℓ} {a}_{ℓ} {e}^{- j \frac{2 πℓ t}{{T}_{m}}} ,$$

where

$${a}_{ℓ} = {\int }_{0}^{T} s ( t ) {e}^{- j \frac{2 πℓ t}{{T}_{m}}} d t .$$

In such examples,

$${a}_{0} = \frac{2}{{T}_{m}} [ ( 1 - ∈ ) {Δ}_{1} - ( 1 + ∈ ) {Δ}_{2} ] + ∈ ,$$

and for a₀=0 (e.g., without any direct current (DC) term, which may corrupt an original signal),

$${Δ}_{2} = \frac{1 - ∈}{1 + ∈} {Δ}_{1} + \frac{∈}{2 ( 1 + ∈ )} {T}_{m} .$$

$$For ℓ \neq 0 , {a}_{ℓ} = \frac{1}{πℓ} [ ( 1 - ∈ ) sin ( \frac{2 {πℓΔ}_{1}}{{T}_{m}} ) - ( 1 + ∈ ) {e}^{- j πℓ t} sin ( \frac{2 {πℓΔ}_{2}}{{T}_{m}} ) ] ,$$

and the Fourier series representation of the 3-level hybrid waveform may be represented by

$$s ( t ) = {\sum }_{ℓ = 1}^{∞} 2 {a}_{ℓ} cos ( \frac{2 πℓ t}{{T}_{m}} ) ( e . g . , {asa}_{ℓ} = {a}_{- ℓ} ) .$$

In examples in which ϵ→0 and a₀=0,

$${Δ}_{2} = {Δ}_{1} = Δ and s ( t ) = {\sum }_{ℓ = 1}^{∞} \frac{2}{πℓ} ( 1 - {e}^{- j πℓ t} ) sin ( \frac{2 πℓΔ}{{T}_{m}} ) cos ( \frac{2 πℓ t}{{T}_{m}} ) .$$

Accordingly, a 2-level waveform may be represented by

$$s ( t ) = {\sum }_{ℓ = 1}^{∞} \frac{4}{πℓ} sin ( \frac{2 πℓ t}{{T}_{m}} )$$

and a 3-level hybrid waveform with an absorptive “OFF” state (e.g., a “perfect” absorptive “OFF” state) may be represented by

$$s ( t ) = {\sum }_{ℓ = 1}^{∞} \frac{4}{πℓ} sin ( \frac{2 πℓΔ}{{T}_{m}} ) cos ( \frac{2 πℓ t}{{T}_{m}} ) ,$$

where the order [symbol] may be an odd value.

In some examples, if ϵ→0, a₀=0, and Δ₂=Δ₁=4, a power of an [symbol] th order harmonic frequency may be represented by

$${a}_{ℓ} = \frac{2}{πℓ} [ sin ( \frac{2 π}{κ} ) ℓ ] ,$$

where

$$κ = \frac{{T}_{m}}{Δ} > 4.$$

The wireless device may select

$$\frac{{T}_{m}}{Δ}$$

such that a power of higher-order harmonic frequencies is reduced (e.g., suppressed). For example, if the wireless device selects

$$κ = \frac{{T}_{m}}{Δ} = 4 ,$$

the power (e.g., | [symbol] |) of the 5th-order harmonic frequencies

$$( e . g . , ℓ = 5 and ℓ = - 5 ) may be \frac{2}{5 π} * 1 ,$$

and the power of the 3rd order harmonic frequencies

$$( e . g . , ℓ = 3 and ℓ = - 3 ) may be \frac{2}{3 π} * 1 ,$$

and the power of the 1st-order harmonic frequencies

$$( e . g . , ℓ = 1 and ℓ = - 1 ) may be \frac{2}{π} * 1.$$

If the wireless device selects

$$κ = \frac{{T}_{m}}{Δ} = 6 ,$$

the power of the 5th-order harmonic frequencies

$$( e . g . , ℓ = 5 and ℓ = - 5 ) may be \frac{2}{5 π} * 0.87 ,$$

the power of the 3rd-order harmonic frequencies

$$( e . g . , ℓ = 3 and ℓ = - 3 ) may be \frac{2}{3 π} * 0 ,$$

and the power of the 1st-order harmonic frequencies

$$( e . g . , ℓ = 1 and ℓ = - 1 ) may be \frac{2}{π} * 0.87 .$$

Accordingly, the wireless device may select a ratio for the waveform parameters

$$\frac{{T}_{m}}{Δ} = 6$$

to suppress the higher-order harmonic frequencies.

In some examples, if the EH-capable device is a RIS (e.g., for a RIS-associated network), the wireless device 210 may select Tₘ, Δ₁, and/or Δ₂ to increase higher-order harmonic frequency suppression (e.g., 10 dB as compared to 4 dB for ϵ=0.25). In examples in which the wireless device communicates with relatively many EH-capable devices, the wireless device may identify a database of various reflection ratios associated with each EH-capable device. In such examples, the wireless device may select respective values or ratios for Tₘ, Δ₁, and/or Δ₂ (e.g., to compromise between suppression of the higher-order harmonic frequencies and loss in 1st order harmonic frequencies) for each of the various reflection ratios.

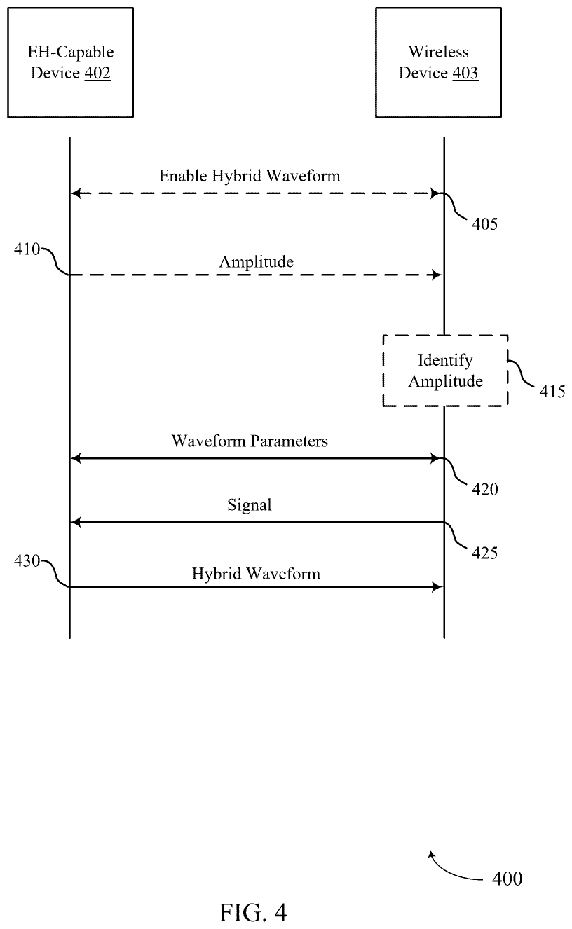

FIG. 4 shows an example of a process flow 400 that supports hybrid waveforms for EH-capable devices in accordance with one or more aspects of the present disclosure. The process flow 400 may implement or may be implemented by aspects of the wireless communications system 100, the wireless communications system 200, or the harmonic level diagram 300. For example, the process flow 400 may be implemented by a wireless device 403 (e.g., a reader device) or an EH-capable device 402, which may be examples of UEs 115 or network entities 105 as described with reference to FIG. 1. For example, the EH-capable device 402 may be an example of a RIS or an A-IoT device as described with reference to FIG. 1.

In the following description of the process flow 400, the operations between the wireless device 403 and the EH-capable device 402 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the wireless device 403 may output, to the EH-capable device 402, control signaling indicating for the EH-capable device to enable a hybrid waveform. For example, the wireless device 403 may output the control signaling in response to determining to enable the hybrid waveform. In some examples, the wireless device 403 may determine to enable the hybrid waveform based on a decrease in a first harmonic frequency level (e.g., first-order harmonic frequency) being less than a threshold or based on a priority associated with suppressing one or more second harmonic frequency levels (e.g., higher-order harmonics, such as 3rd or 5th order harmonics). For example, the wireless device 403 may identify one or more power levels associate with the one or more second harmonic frequencies in examples in which the EH-capable device 402 is enabled to use the hybrid waveform, and may determine to enable the hybrid waveform based on the one or more power levels.

In some examples, at 410, the wireless device 403 receive an indication of a first amplitude level from the EH-capable device 402. For example, the first amplitude level may be an amplitude associated with residual reflection during an “OFF” state of a hybrid waveform to be output by the EH-capable device 402. Additionally, or alternatively, at 415, the wireless device 403 may identify the first amplitude level from a database. For example, the database may include one or more “OFF” state reflection amplitudes of a hybrid waveform to be output by a corresponding one or more EH-capable devices (e.g., including the EH-capable device 402).

At 420, the wireless device 403 may communicate control signaling indicating one or more waveform parameters associated with the hybrid waveform with the EH-capable device 402 (e.g., and/or a receiving device). For example, the wireless device 403 may indicate a first time duration associated with a first reflection phase of the hybrid waveform and a second time duration associated with a second reflection phase of the hybrid waveform. In some examples, the first reflection phase and the second reflection phase may be associated with a same amplitude level of phase, but where the first reflection phase and the second reflection phase are out of phase (e.g., each have a same magnitude of phase but with a different sign, such as +1 or −1). For example, the first reflection phase and the second reflection phase may be associated with an amplitude level that is greater than the first amplitude level of a third reflection phase. In some examples, the wireless device 403 may communicate the one or more waveform parameters associated with the hybrid waveform with the EH-capable device 402 during a synchronization phase.

In some examples, the first time duration and the second time duration may be associated with a period of the hybrid waveform. For example, a relationship between the first time duration, the second time duration, and/or the period may determine the respective power levels of the first harmonic frequency and the one or more second harmonic frequencies. In some examples, the wireless device 403 may compute the first time duration and the second time duration based on the first amplitude level. For example, the wireless device 403 may compute the first time duration and the second time duration to reduce (e.g., minimize) the power of the one or more second harmonic frequencies, to mitigate a reduction in the power of the first harmonic frequency, or both.

At 425, the EH-capable device 402 may receive a signal from the wireless device 403. At 430, the EH-capable device 402 may output the hybrid waveform to the wireless device (e.g., or to the receiving device) based on a backscatter of the received signal. For example, the EH-capable device 402 may backscatter the received signal in accordance with the waveform parameters at the respective amplitude levels of the first, second, and third reflection phases.

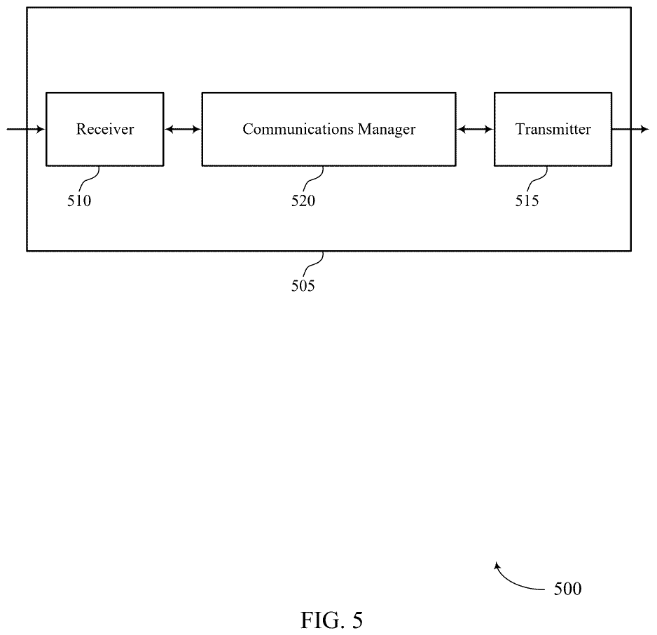

FIG. 5 shows a block diagram 500 of a device 505 that supports hybrid waveforms for EH-capable devices in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to hybrid waveforms for EH-capable devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to hybrid waveforms for EH-capable devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of hybrid waveforms for EH-capable devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The communications manager 520 is capable of, configured to, or operable to support a means for receiving a signal from a wireless device. The communications manager 520 is capable of, configured to, or operable to support a means for transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Additionally, or alternatively, the communications manager 520 may support wireless communications in accordance with examples as disclosed herein. For example, the communications manager 520 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The communications manager 520 is capable of, configured to, or operable to support a means for transmitting a signal to an EH-capable device. The communications manager 520 is capable of, configured to, or operable to support a means for receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for backscattering signals using hybrid waveforms, which may enable reduced processing and reduced power consumption.

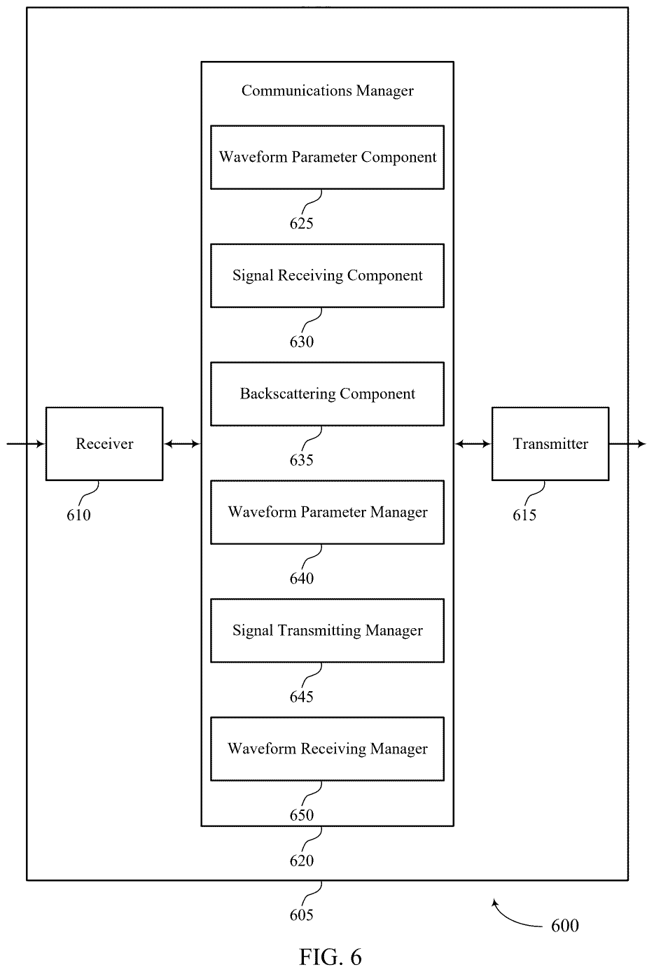

FIG. 6 shows a block diagram 600 of a device 605 that supports hybrid waveforms for EH-capable devices in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to hybrid waveforms for EH-capable devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to hybrid waveforms for EH-capable devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of hybrid waveforms for EH-capable devices as described herein. For example, the communications manager 620 may include a waveform parameter component 625, a signal receiving component 630, a backscattering component 635, a waveform parameter manager 640, a signal transmitting manager 645, a waveform receiving manager 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The waveform parameter component 625 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The signal receiving component 630 is capable of, configured to, or operable to support a means for receiving a signal from a wireless device. The backscattering component 635 is capable of, configured to, or operable to support a means for transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Additionally, or alternatively, the communications manager 620 may support wireless communications in accordance with examples as disclosed herein. The waveform parameter manager 640 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The signal transmitting manager 645 is capable of, configured to, or operable to support a means for transmitting a signal to an EH-capable device. The waveform receiving manager 650 is capable of, configured to, or operable to support a means for receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

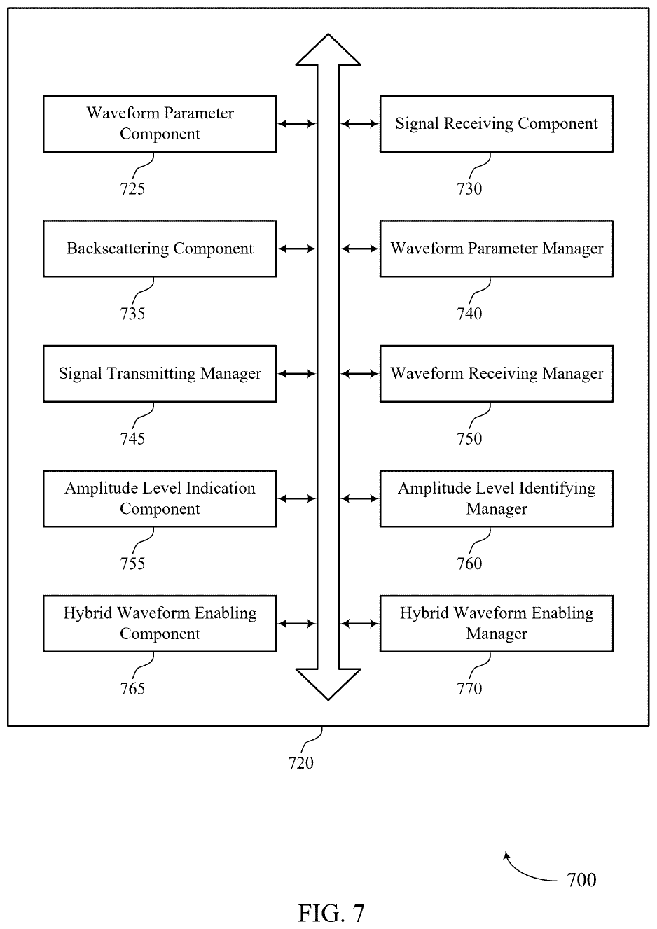

FIG. 7 shows a block diagram 700 of a communications manager 720 that supports hybrid waveforms for EH-capable devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of hybrid waveforms for EH-capable devices as described herein. For example, the communications manager 720 may include a waveform parameter component 725, a signal receiving component 730, a backscattering component 735, a waveform parameter manager 740, a signal transmitting manager 745, a waveform receiving manager 750, an amplitude level indication component 755, an amplitude level identifying manager 760, a hybrid waveform enabling component 765, a hybrid waveform enabling manager 770, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The waveform parameter component 725 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The signal receiving component 730 is capable of, configured to, or operable to support a means for receiving a signal from a wireless device. The backscattering component 735 is capable of, configured to, or operable to support a means for transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

In some examples, the amplitude level indication component 755 is capable of, configured to, or operable to support a means for transmitting an indication of the first amplitude level.

In some examples, the control signaling is communicated during a synchronization phase associated with the EH-capable device and a UE.

In some examples, the first time duration and the second time duration are associated with a period of the hybrid waveform.

In some examples, the first time duration and the second time duration are based on the first amplitude level. In some examples, the first time duration and the second time duration are associated with a set of power values associated with a set of harmonic frequencies.

In some examples, the set of power values include one or more minimum power values associated with the set of harmonic frequencies.

In some examples, the hybrid waveform enabling component 765 is capable of, configured to, or operable to support a means for receiving control signaling indicating that the hybrid waveform is enabled based on the set of power values, a decrease associated with a first-order harmonic frequency, or both.

In some examples, the EH-capable device is an A-IoT device or a RIS.

Additionally, or alternatively, the communications manager 720 may support wireless communications in accordance with examples as disclosed herein. The waveform parameter manager 740 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The signal transmitting manager 745 is capable of, configured to, or operable to support a means for transmitting a signal to an EH-capable device. The waveform receiving manager 750 is capable of, configured to, or operable to support a means for receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

In some examples, the amplitude level identifying manager 760 is capable of, configured to, or operable to support a means for receiving, from the EH-capable device, an indication of the first amplitude level. In some examples, the amplitude level identifying manager 760 is capable of, configured to, or operable to support a means for identifying the first amplitude level from a database. In some examples, the first time duration and the second time duration are based on the first amplitude level. In some examples, the first time duration and the second time duration are associated with a set of power values associated with a set of harmonic frequencies. In some examples, the set of power values include one or more minimum power values associated with the set of harmonic frequencies.

In some examples, the hybrid waveform enabling manager 770 is capable of, configured to, or operable to support a means for determining to enable the hybrid waveform based on the set of power values, a decrease associated with a first-order harmonic frequency, or both. In some examples, the hybrid waveform enabling manager 770 is capable of, configured to, or operable to support a means for transmitting, to the EH-capable device, control signaling indicating that the hybrid waveform is enabled.

In some examples, the control signaling is communicated during a synchronization phase associated with the EH-capable device and the wireless device. In some examples, the first time duration and the second time duration are associated with a period of the hybrid waveform. In some examples, the EH-capable device is an A-IoT device or a RIS.

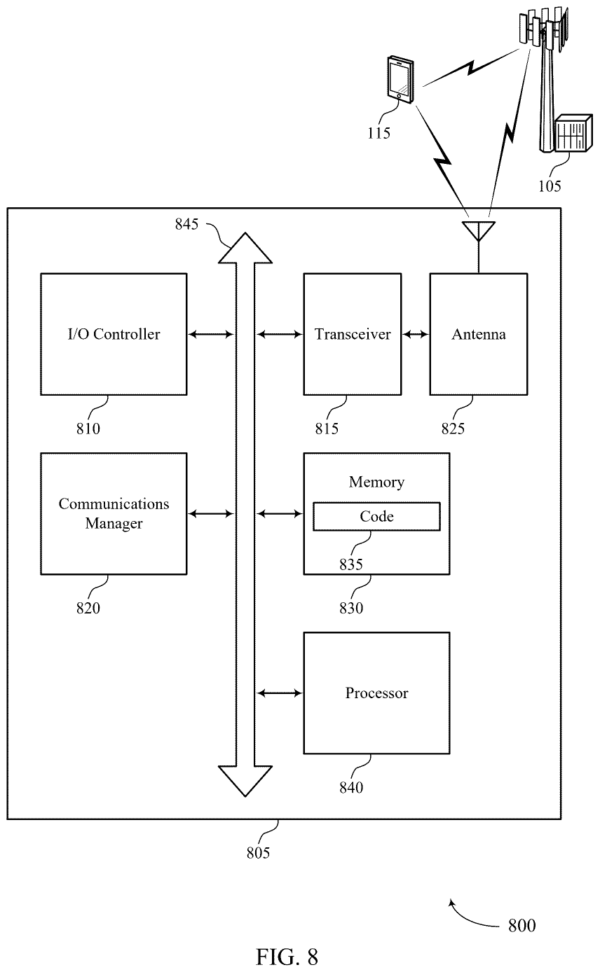

FIG. 8 shows a diagram of a system 800 including a device 805 that supports hybrid waveforms for EH-capable devices in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting hybrid waveforms for EH-capable devices). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The communications manager 820 is capable of, configured to, or operable to support a means for receiving a signal from a wireless device. The communications manager 820 is capable of, configured to, or operable to support a means for transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

Additionally, or alternatively, the communications manager 820 may support wireless communications in accordance with examples as disclosed herein. For example, the communications manager 820 is capable of, configured to, or operable to support a means for communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The communications manager 820 is capable of, configured to, or operable to support a means for transmitting a signal to an EH-capable device. The communications manager 820 is capable of, configured to, or operable to support a means for receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration.

By including or configuring the communications manager 820 in accordance with examples as described herein, the device 805 may support techniques for backscattering signals using hybrid waveforms, which may enable improved communication reliability, improved user experience related to reduced processing, and reduced power consumption.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of hybrid waveforms for EH-capable devices as described herein, or the at least one processor 840 and the at least one memory 830 may be otherwise configured to, individually or collectively, perform or support such operations.

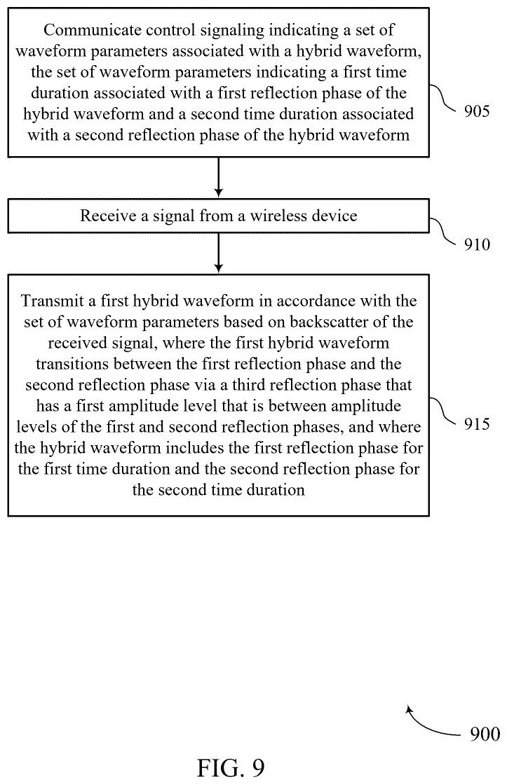

FIG. 9 shows a flowchart illustrating a method 900 that supports hybrid waveforms for EH-capable devices in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The operations of 905 may be performed in accordance with examples as disclosed herein. In some examples, aspects of the operations of 905 may be performed by a waveform parameter component 725 as described with reference to FIG. 7.

At 910, the method may include receiving a signal from a wireless device. The operations of 910 may be performed in accordance with examples as disclosed herein. In some examples, aspects of the operations of 910 may be performed by a signal receiving component 730 as described with reference to FIG. 7.

At 915, the method may include transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration. The operations of 915 may be performed in accordance with examples as disclosed herein. In some examples, aspects of the operations of 915 may be performed by a backscattering component 735 as described with reference to FIG. 7.

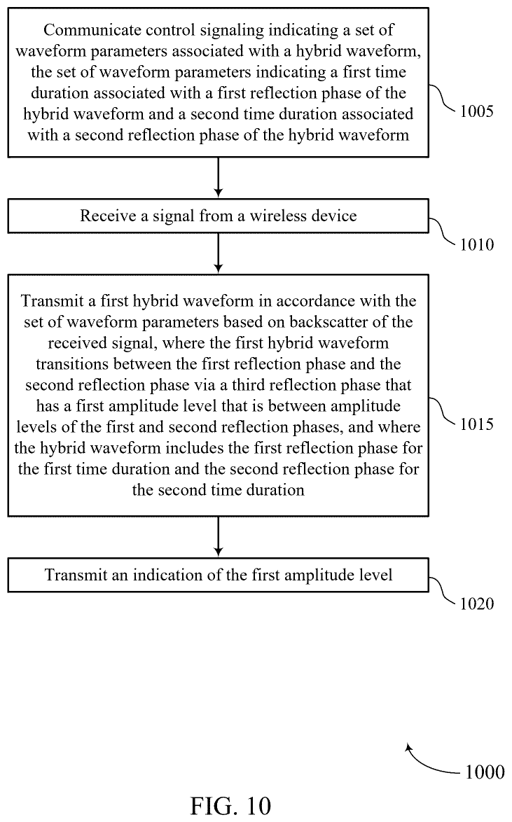

FIG. 10 shows a flowchart illustrating a method 1000 that supports hybrid waveforms for EH-capable devices in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The operations of 1005 may be performed in accordance with examples as disclosed herein. In some examples, aspects of the operations of 1005 may be performed by a waveform parameter component 725 as described with reference to FIG. 7.

At 1010, the method may include receiving a signal from a wireless device. The operations of 1010 may be performed in accordance with examples as disclosed herein. In some examples, aspects of the operations of 1010 may be performed by a signal receiving component 730 as described with reference to FIG. 7.

At 1015, the method may include transmitting a first hybrid waveform in accordance with the set of waveform parameters based on backscatter of the received signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration. The operations of 1015 may be performed in accordance with examples as disclosed herein. In some examples, aspects of the operations of 1015 may be performed by a backscattering component 735 as described with reference to FIG. 7.

At 1020, the method may include transmitting an indication of the first amplitude level. The operations of 1020 may be performed in accordance with examples as disclosed herein. In some examples, aspects of the operations of 1020 may be performed by an amplitude level indication component 755 as described with reference to FIG. 7.

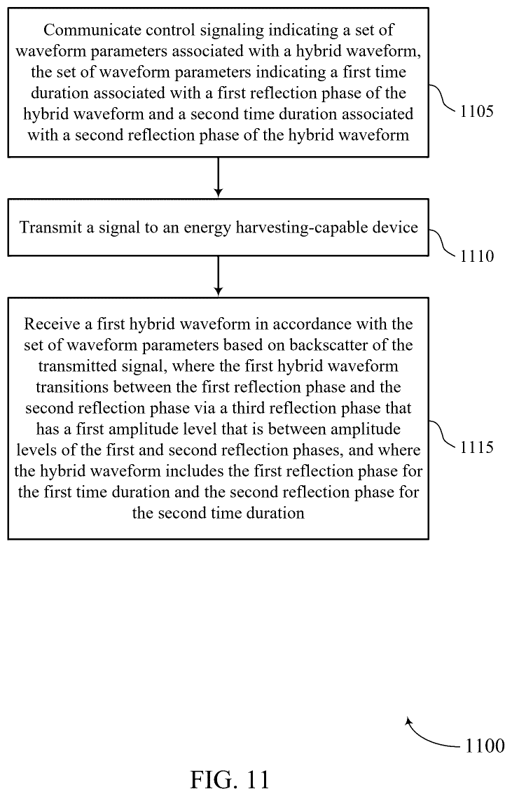

FIG. 11 shows a flowchart illustrating a method 1100 that supports hybrid waveforms for EH-capable devices in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform. The operations of 1105 may be performed in accordance with examples as disclosed herein. In some examples, aspects of the operations of 1105 may be performed by a waveform parameter manager 740 as described with reference to FIG. 7.

At 1110, the method may include transmitting a signal to an EH-capable device. The operations of 1110 may be performed in accordance with examples as disclosed herein. In some examples, aspects of the operations of 1110 may be performed by a signal transmitting manager 745 as described with reference to FIG. 7.

At 1115, the method may include receiving a first hybrid waveform in accordance with the set of waveform parameters based on backscatter of the transmitted signal, where the first hybrid waveform transitions between the first reflection phase and the second reflection phase via a third reflection phase that has a first amplitude level that is between amplitude levels of the first and second reflection phases, and where the hybrid waveform includes the first reflection phase for the first time duration and the second reflection phase for the second time duration. The operations of 1115 may be performed in accordance with examples as disclosed herein. In some examples, aspects of the operations of 1115 may be performed by a waveform receiving manager 750 as described with reference to FIG. 7.

The following provides an overview of aspects of the present disclosure:

Aspect 1: A method for wireless communications by an EH-capable device, comprising: communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform; receiving a signal from a wireless device; and transmitting a first hybrid waveform in accordance with the set of waveform parameters based at least in part on backscatter of the received signal, wherein the first hybrid waveform transitions between the first reflection phase and the second reflection phase via a third reflection phase that has a first amplitude level that is between amplitude levels of the first and second reflection phases, and wherein the hybrid waveform comprises the first reflection phase for the first time duration and the second reflection phase for the second time duration.

Aspect 2: The method of aspect 1, further comprising: transmitting an indication of the first amplitude level.

Aspect 3: The method of any of aspects 1 through 2, wherein the control signaling is communicated during a synchronization phase associated with the EH-capable device and a UE.

Aspect 4: The method of any of aspects 1 through 3, wherein the first time duration and the second time duration are associated with a period of the hybrid waveform.

Aspect 5: The method of any of aspects 1 through 4, wherein the first time duration and the second time duration are based at least in part on the first amplitude level, and the first time duration and the second time duration are associated with a set of power values associated with a set of harmonic frequencies.

Aspect 6: The method of aspect 5, wherein the set of power values comprise one or more minimum power values associated with the set of harmonic frequencies.

Aspect 7: The method of any of aspects 5 through 6, further comprising: receiving control signaling indicating that the hybrid waveform is enabled based at least in part on the set of power values, a decrease associated with a first-order harmonic frequency, or both.

Aspect 8: The method of any of aspects 1 through 7, wherein the EH-capable device is an A-IoT device or a RIS.

Aspect 9: A method for wireless communications by a wireless device, comprising: communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform; transmitting a signal to an EH-capable device; and receiving a first hybrid waveform in accordance with the set of waveform parameters based at least in part on backscatter of the transmitted signal, wherein the first hybrid waveform transitions between the first reflection phase and the second reflection phase via a third reflection phase that has a first amplitude level that is between amplitude levels of the first and second reflection phases, and wherein the hybrid waveform comprises the first reflection phase for the first time duration and the second reflection phase for the second time duration.

Aspect 10: The method of aspect 9, further comprising: receiving, from the EH-capable device, an indication of the first amplitude level.

Aspect 11: The method of any of aspects 9 through 10, further comprising: identifying the first amplitude level from a database.

Aspect 12: The method of any of aspects 9 through 11, wherein the first time duration and the second time duration are based at least in part on the first amplitude level, and the first time duration and the second time duration are associated with a set of power values associated with a set of harmonic frequencies.

Aspect 13: The method of aspect 12, wherein the set of power values comprise one or more minimum power values associated with the set of harmonic frequencies.

Aspect 14: The method of any of aspects 12 through 13, further comprising: determining to enable the hybrid waveform based at least in part on the set of power values, a decrease associated with a first-order harmonic frequency, or both; and transmitting, to the EH-capable device, control signaling indicating that the hybrid waveform is enabled.

Aspect 15: The method of any of aspects 9 through 14, wherein the control signaling is communicated during a synchronization phase associated with the EH-capable device and the wireless device.

Aspect 16: The method of any of aspects 9 through 15, wherein the first time duration and the second time duration are associated with a period of the hybrid waveform.

Aspect 17: The method of any of aspects 9 through 16, wherein the EH-capable device is an A-IoT device or a RIS.

Aspect 18: An EH-capable device for wireless communications, comprising one or more memories storing processor-executable code, and one or more processors coupled with the one or more memories and individually or collectively operable to execute the code to cause the EH-capable device to perform a method of any of aspects 1 through 8.

Aspect 19: An EH-capable device for wireless communications, comprising at least one means for performing a method of any of aspects 1 through 8.

Aspect 20: A non-transitory computer-readable medium storing code for wireless communications, the code comprising instructions executable by one or more processors to perform a method of any of aspects 1 through 8.

Aspect 21: A wireless device for wireless communications, comprising one or more memories storing processor-executable code, and one or more processors coupled with the one or more memories and individually or collectively operable to execute the code to cause the wireless device to perform a method of any of aspects 9 through 17.

Aspect 22: A wireless device for wireless communications, comprising at least one means for performing a method of any of aspects 9 through 17.

Aspect 23: A non-transitory computer-readable medium storing code for wireless communications, the code comprising instructions executable by one or more processors to perform a method of any of aspects 9 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An energy harvesting-capable device, comprising:
one or more memories storing processor-executable code; and
one or more processors coupled with the one or more memories and individually or collectively operable to execute the code to cause the energy harvesting-capable device to:
communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform;
receive a signal from a wireless device; and
transmit a first hybrid waveform in accordance with the set of waveform parameters based at least in part on backscatter of the received signal, wherein the first hybrid waveform transitions between the first reflection phase and the second reflection phase via a third reflection phase that has a first amplitude level that is between amplitude levels of the first and second reflection phases, and wherein the hybrid waveform comprises the first reflection phase for the first time duration and the second reflection phase for the second time duration.

2. The energy harvesting-capable device of claim 1, wherein the one or more processors are individually or collectively further operable to execute the code to cause the energy harvesting-capable device to:
transmit an indication of the first amplitude level.

3. The energy harvesting-capable device of claim 1, wherein the control signaling is communicated during a synchronization phase associated with the energy harvesting-capable device and a user equipment (UE).

4. The energy harvesting-capable device of claim 1, wherein the first time duration and the second time duration are associated with a period of the hybrid waveform.

5. The energy harvesting-capable device of claim 1, wherein:
the first time duration and the second time duration are based at least in part on the first amplitude level, and
the first time duration and the second time duration are associated with a set of power values associated with a set of harmonic frequencies.

6. The energy harvesting-capable device of claim 5, wherein the set of power values comprise one or more minimum power values associated with the set of harmonic frequencies.

7. The energy harvesting-capable device of claim 5, wherein the one or more processors are individually or collectively further operable to execute the code to cause the energy harvesting-capable device to:
receive control signaling indicating that the hybrid waveform is enabled based at least in part on the set of power values, a decrease associated with a first-order harmonic frequency, or both.

8. The energy harvesting-capable device of claim 1, wherein the energy harvesting-capable device is an ambient internet-of-things device or a reflective intelligent surface.

9. A wireless device, comprising:
one or more memories storing processor-executable code; and
one or more processors coupled with the one or more memories and individually or collectively operable to execute the code to cause the wireless device to:
communicate control signaling indicating a set of waveform parameters associated with a hybrid waveform, the set of waveform parameters indicating a first time duration associated with a first reflection phase of the hybrid waveform and a second time duration associated with a second reflection phase of the hybrid waveform;
transmit a signal to an energy harvesting-capable device; and
receive a first hybrid waveform in accordance with the set of waveform parameters based at least in part on backscatter of the transmitted signal, wherein the first hybrid waveform transitions between the first reflection phase and the second reflection phase via a third reflection phase that has a first amplitude level that is between amplitude levels of the first and second reflection phases, and wherein the hybrid waveform comprises the first reflection phase for the first time duration and the second reflection phase for the second time duration.

10. The wireless device of claim 9, wherein the one or more processors are individually or collectively further operable to execute the code to cause the wireless device to:
receive, from the energy harvesting-capable device, an indication of the first amplitude level.

11. The wireless device of claim 9, wherein the one or more processors are individually or collectively further operable to execute the code to cause the wireless device to:
identify the first amplitude level from a database.

12. The wireless device of claim 9, wherein:
the first time duration and the second time duration are based at least in part on the first amplitude level, and
the first time duration and the second time duration are associated with a set of power values associated with a set of harmonic frequencies.

13. The wireless device of claim 12, wherein the set of power values comprise one or more minimum power values associated with the set of harmonic frequencies.

14. The wireless device of claim 12, wherein the one or more processors are individually or collectively further operable to execute the code to cause the wireless device to:
determine to enable the hybrid waveform based at least in part on the set of power values, a decrease associated with a first-order harmonic frequency, or both; and
transmit, to the energy harvesting-capable device, control signaling indicating that the hybrid waveform is enabled.

15. The wireless device of claim 9, wherein the control signaling is communicated during a synchronization phase associated with the energy harvesting-capable device and the wireless device.

16. The wireless device of claim 9, wherein the first time duration and the second time duration are associated with a period of the hybrid waveform.

17. The wireless device of claim 9, wherein the energy harvesting-capable device is an ambient internet-of-things device or a reflective intelligent surface.

18. A method for wireless communications by an energy harvesting-capable device, comprising:
communicating control signaling indicating a set of waveform parameters associated with a hybrid waveform, the set of waveform parameters indicating a first time duration associated with a first reflection phase of the hybrid waveform and a second time duration associated with a second reflection phase of the hybrid waveform;
receiving a signal from a wireless device; and
transmitting a first hybrid waveform in accordance with the set of waveform parameters based at least in part on backscatter of the received signal, wherein the first hybrid waveform transitions between the first reflection phase and the second reflection phase via a third reflection phase that has a first amplitude level that is between amplitude levels of the first and second reflection phases, and wherein the hybrid waveform comprises the first reflection phase for the first time duration and the second reflection phase for the second time duration.

19. The method of claim 18, further comprising:
transmitting an indication of the first amplitude level.

20. The method of claim 18, wherein the control signaling is communicated during a synchronization phase associated with the energy harvesting-capable device and a user equipment (UE).
